(19) United States
(12) Patent Application Publication
(10) Pub. No.: US 2003/0118724 A1
(43) Pub. Date: Jun. 26, 2003

(54) Recording medium surface coating apparatus and method

(75) Inventor: Jin-Hong Kim, Gyeonggi-Do (KR)

Correspondence Address: FLESHNER & KIM, LLP, P.O. Box 221200, Chantilly, VA, 20153-1200, US

(73) Assignee: LG Electronics Inc.

(21) Appl. No.: 10/321,371

(22) Filed: Dec. 18, 2002

(30) Foreign Application Priority Data
Dec. 21, 2001 (KR) 82804/2001

(51) Int. Cl. B05D 3/12

(52) U.S. Cl. 427/240; 118/52

(57) ABSTRACT

A recording medium surface coating apparatus includes: a medium mounting unit having a rotational shaft and a mounting surface with a plurality of medium mounting recesses in which a recording medium is mounted, the medium mounting unit being coupled to the rotational shaft and rotated; a coating material supply unit installed along the rotational shaft and supplying a coating material to the surface of the recording medium; and a driving unit for rotating the medium mounting unit.

### BACKGROUND OF THE INVENTION

1. Field of the Invention

The present invention relates to a recording medium surface coating method and recording/reproducing apparatus.

2. Description of the Background Art

A recording medium for storing high density data includes a magnetic disk such as an HDD (Hard Disk Drive) using a magnetic technology, an optical disk such as a CD or a DVD using an optical method, and a magneto-optical disk using the magneto-optical effects.

Generally, the optical disk or the magneto-optical disk has a lamella structure consisting of a substrate forming a main body of a disk, a data recording layer for recording data, and a protective layer for protecting the data recording layer.

That is, in case of a read-only memory (ROM) disk, pits are formed in a circumferential direction of the disk, and a reflection layer is additionally provided to reflect light irradiated to the disk.

In the case of recordable disks such as CD-R, DVD-R, data can be recorded only once using on a recordable dye. In the case of rewritable disks such as CD-RW, DVD-RW, data can be repeatedly written, read and erased, on recording layers such as a phase change material or a magneto-optical material which is additionally provided on pre-pits and the reflection layer.

FIG. 1 shows a sectional view of the construction of a general recording medium, and FIG. 2 is showing a principle of recording/reproducing for the recording medium of FIG. 1.

As shown in FIGS. 1 and 2, the disk, the recording medium, includes a substrate 4, a reflection layer 3 formed on the substrate, a data recording layer 2 formed on the reflection layer 3 for recording/reproducing data, and a protective layer 1 for protecting the data recording layer 2.

The laser beam (L) irradiated from a light transmitting/receiving unit (not shown) is focused through an objective lens 5, first transmitted through the protective layer 1 made of a transparent material to reach the data recording layer 2, reflected from the reflection layer 3 and returned to the light transmitting/receiving unit, thereby recording/reproducing data on the recording medium.

The reason why the method in which the light is transmitted through the protective layer 1 to reach the data recording layer 2 is adopted to prevent the recording layer from being damaged by finger print, dust or contaminant, etc. by forming the protective layer 1 on the recording layer 2.

The record density of the disk is determined by the size of focused light, and the size of light is determined by a wavelength λ of a light source in consideration of diffraction and a numeric aperture of a used lens.

However, in the case that the method of optically recording/reproducing a signal by using such a disk as described above is adopted, as shown in FIG. 1, since light reaches the recording layer 2 after transmitting through the protective layer 1, it is impossible to use a lens with the high index of refraction for the thick protective layer 1.

In addition, for the case of using an optical flying head, a uniform thickness of protective layer is required to maintain a distance between the objective lens 5 and the recording layer 2 constantly in order to let a focal point of light focussed through the objective lens 5 to be formed on the recording layer 2.

Moreover, with this structure, in case of using a lens with a high numerical aperture, the effects of the coma aberration becomes important as noted in the following formula, so the focal point can be deviated from the recording layer 2 when the disk is tilted.

$$Coma , W ( r , Φ ) = \frac{( {n}^{2} - 1 )}{8 {n}^{2}} \cdot t \cdot {( NA )}^{3} \cdot α {γ}^{3} \cdot cos Φ$$

Wherein ‘t’ is the thickness of the protective layer which the laser beam should pass to reach the recording layer, NA is the numerical aperture of the objective lens, α is a tilt angle of the disk, and ‘n’ is an index of refraction of the protective layer.

Accordingly, in order to enlarge the recording density of the disk, the thickness of the protective layer 1 should be uniform and the data recording layer 3 should be formed as close as possible to the lens surface. Therefore, the protective layer 1 should be thin and uniform.

FIGS. 3 and 4 are conceptual view showing by steps a method for coating the protective layer on the surface of a disk by a spin coating method, and FIGS. 5 and 6 are graphs showing irregularity in the thickness of the protective layer formed by the spin coating method, of which X axis indicates a distance from the center of the disk to an outer side and Y axis indicates the thickness.

The spin coating method, one of methods for forming a protective layer on the disk, is that a thermosetting resin 6 is coated in a circular form at the central portion of the surface of the data recording layer 3 of the disk D and then the disk D is rotated so that the thermosetting resin 6 can be uniformly distributed onto the surface of the disk D by virtue of the centrifugal force, thereby forming the protective layer 1.

However, as for the conventional spin coating method, since the thermosetting resin is distributed onto the surface of the disk only relying on the centrifugal force according to rotation of the disk without an aid of any means for making the thickness of the protective layer 1 to be uniform, the thickness at the inner circumferential portion or at the outer circumferential portion of the disk is inevitably uneven compared to other portion of the disk.

Especially, in the case that the thickness of the protective layer 1 is not even, a path difference occurs at each portion, causing degradation of recording and reproducing characteristics.

### SUMMARY OF THE INVENTION

Therefore, an object of the present invention is to provide a recording medium surface coating apparatus and method that are capable of uniformly coating the surface of a recording medium.

To achieve these and other advantages and in accordance with the purpose of the present invention, as embodied and broadly described herein, there is provided a recording medium surface coating apparatus including: a medium mounting unit having a rotational shaft and a mounting surface with a plurality of medium mounting recesses in which a recording medium is mounted, the medium mounting unit being coupled to the rotational shaft and rotated; a coating material supply unit installed along the rotational shaft and supplying a coating material to a surface of the recording medium; and a driving unit for rotating the medium mounting unit.

To achieve the above objects, there is also provided a surface coating apparatus including: a mounting unit having a rotational shaft and a mounting surface with a plurality of medium mounting recesses on which a surface-process object is mounted, the mounting unit being coupled to the rotational shaft and rotated; a coating material supply unit installed along the rotational shaft and supplying a coating material to a surface of the surface-process object; and a driving unit for rotating the mounting unit.

To achieve the above objects, there is also provided a recording medium coating method including the steps of: inserting a plurality of recording mediums into medium mounting recesses of a mounting unit; rotating the mounting unit; supplying a coating material onto the mounting unit to coat a coating material on the surface of the recording medium by using a centrifugal force according to rotation of the mounting unit; and finishing the coating operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing the construction of a general recording medium;

FIG. 2 is a view showing a recording/reproducing principle of the recording medium of FIG. 1;

FIGS. 3 and 4 are conceptual views showing by steps a method for coating a protective layer on the surface of a disk by a spin coating method;

FIGS. 5 and 6 are graphs showing irregularity in the thickness of the protective layer formed by the spin coating method;

FIG. 7 is a sectional view of a recording medium surface coating apparatus in accordance with the present invention;

FIG. 8 is a plan view of the coating apparatus of FIG. 7 with four medium mounting recesses;

FIG. 9 is a plan view of the coating apparatus of FIG. 7 with seven medium mounting recesses;

FIG. 10 is a sectional view of the coating apparatus of FIG. 7 before a recording medium is mounted;

FIG. 11 is a sectional view of the coating apparatus of FIG. 7 after the recording medium is mounted; and

FIG. 12 is a sectional view of the coating apparatus of FIG. 7 with a fixing unit installed at the bottom of the medium mounting recess.

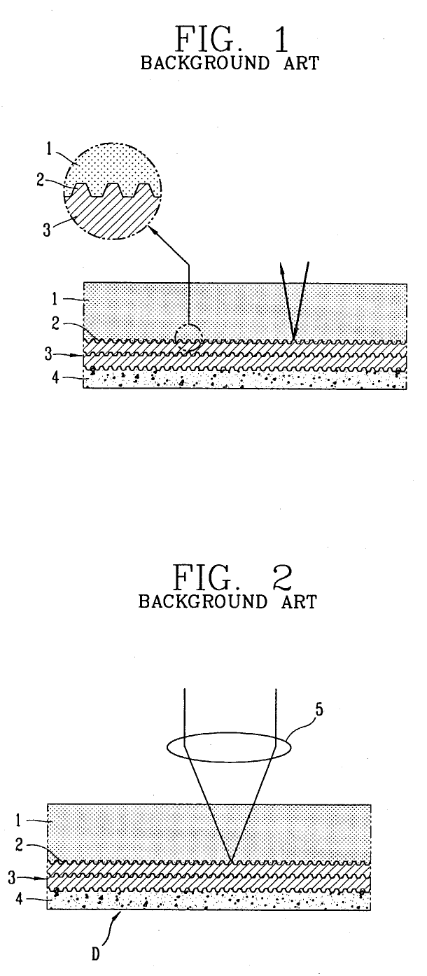

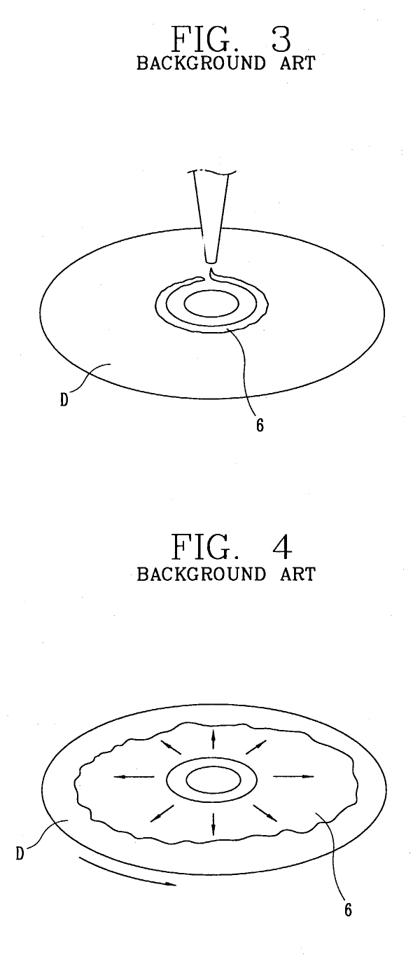

### DETAILED DESCRIPTION OF THE PREFERRED EMBODIMENTS

Reference will now be made in detail to the preferred embodiments of the present invention, examples of which are illustrated in the accompanying drawings.

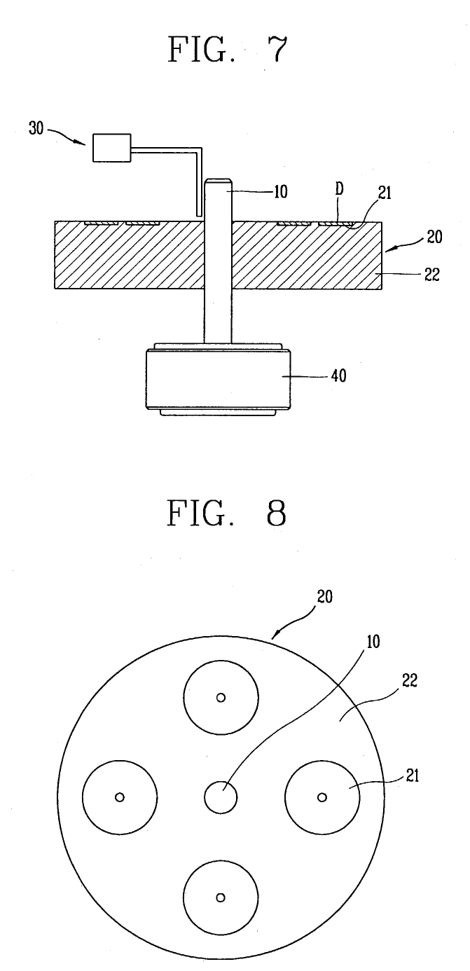

With reference to FIG. 7, a recording medium surface coating apparatus of the present invention includes: a medium mounting unit 20 composing of a rotational shaft 10, and a mounting surface 22 having a plurality of medium mounting recesses 21 on which a recording medium D is mounted, and being coupled to the rotational shaft 10 and rotated; a coating material supply unit 30 installed along the rotational shaft 10 and supplying a coating material onto the surface of the recording medium D; and a driving unit 40 for rotating the medium mounting unit 20.

The recording medium D includes an optical disk, a photo-magnetic disk or the like. The coating apparatus of the present invention can be adoptable to any subject which requires a uniform thickness on its surface. The recording medium D is typically in a circular form.

The coating material forms a protective layer to protect a data recording layer of the recording medium D. As the coating material, a thermosetting resin is usually used which allows a laser beam generated from an optical device (not shown) to transmit therethrough. In this respect, however, any other particular material can be used according to conditions under which a recording medium is used.

The rotational shaft 10 of the medium mounting unit 20 is connected to a driving shaft (not shown) of the driving unit 40 and rotates the medium mounting unit 20.

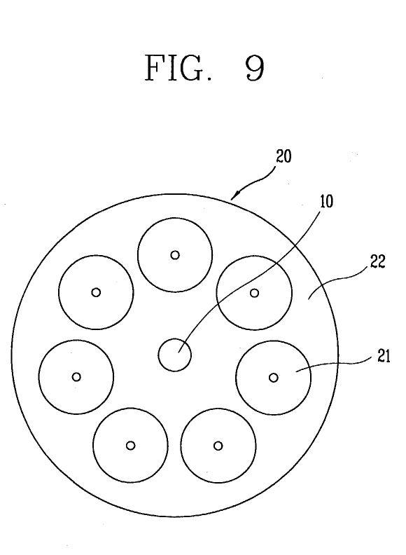

As shown in FIGS. 8 and 9, the mounting surface 22 are formed in a circular shape, on which the medium mounting recesses 21 (four ones in FIG. 8 and seven ones in FIG. 9), in which the recording medium D is mounted, are formed in a circular form centering around the rotational shaft 10. At a distance from the rotational shaft 10, a region where a coating material is formed with a uniform thickness. The medium mounting recess 21 is formed at the region.

As shown in FIGS. 10 and 11, the medium mounting recess 21 is formed with the same depth as the thickness of the recording medium D so that the coating material can be smoothly flown.

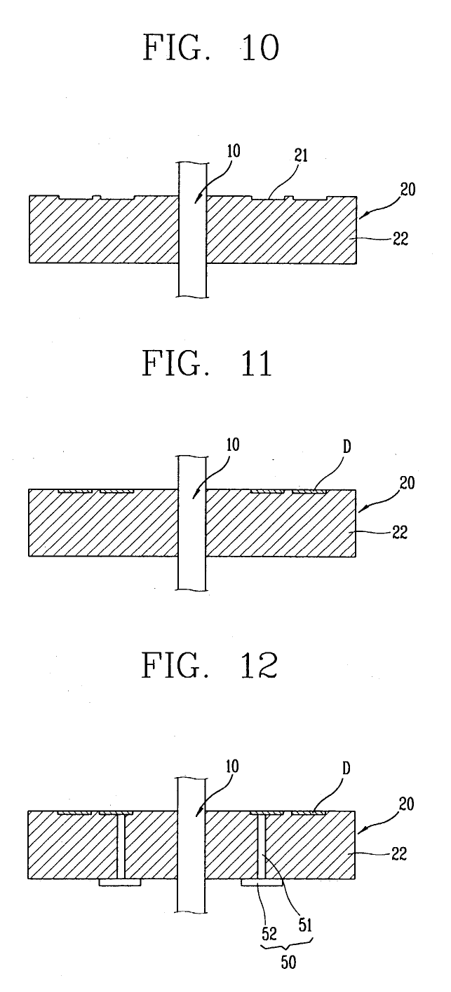

Especially, a fixing unit 50 may be connected and installed at the medium mounting unit 20 to fix the recording medium D when the mounting surface 22 is rotated for coating. As for the fixing unit 50, as shown in FIG. 12, a through hole 51 is formed at the bottom of the medium mounting recess 21 and connected to a vacuum pump 52, so as to form vacuum below the recording medium D when the medium mounting unit 20 is rotated, thereby fixing the recording medium D.

A coating material supply unit 30 is connected and installed along the rotational shaft 10 to supply a coating material to coat the surface of the recording medium.

The operation of the recording medium surface coating apparatus constructed as described above will now be explained.

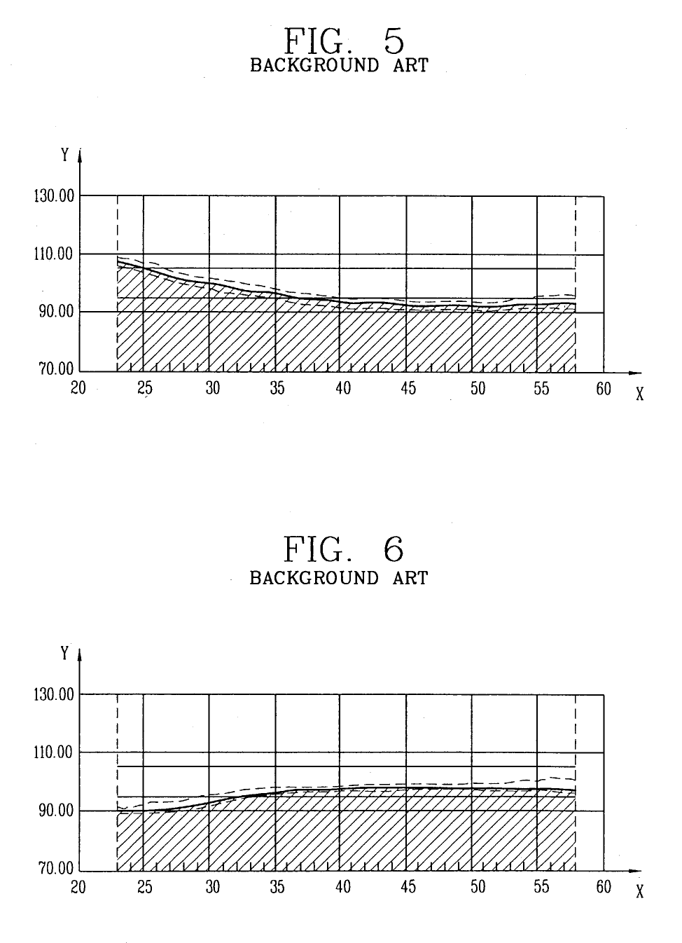

First, the principle of the present invention will now be described as follows. When the surface of the recording medium is coated with coating material, the irregularity of the thickness in the coating is affected by viscosity of a coating material and a rotational speed and rotational time in coating. As shown in FIGS. 5 and 6, the irregularity is severe at the inner circumferential portion or the outer circumferential portion of the circular recording medium, whereas the thickness at the portion between the inner circumferential portion and the outer circumferential portion is comparatively uniform.

For this reason, the recording medium surface coating apparatus and method of the present invention adopts the spin coating method that a coating material being supplied flows onto the surface of a recording medium by rotation in order to form a protective layer at the surface of the recording medium.

In this respect, in the present invention, importantly, the center of rotation does not lie on the center of the recording medium but on the side of the recording medium, in other words, the recording medium is placed in the vicinity of the rotational shaft, thereby enabling to perform a coating with a uniform thickness.

That is, the recording medium D is mounted on the medium mounting recess 21 formed on the mounting surface 22, and the medium mounting unit 20 starts rotating centering around the rotational shaft 10 by the driving unit 40.

Vacuum is formed between the bottom of the recoding medium D and the medium mounting recess 12 through the through hole 51, so that the recording medium D can be fixed at the medium mounting recess 21.

The coating material is supplied to the center of the mounting surface 22 by the coating material supply unit 30 along with rotation of the medium mounting unit 20, and the coating material flows in a radial direction from the rotational shaft 10 according to a centrifugal force.

Accordingly, a protective layer is formed with a certain thickness with the coating material at the surface of the recording medium D, which is then exposed to ultraviolet ray for hardening.

As so far described, the recording medium surface coating apparatus and method 0 of the present invention solves the problem of the conventional art caused due to an edge bead effects that the thickness of coating is not uniform at the edge portion of the recording medium caused by the surface tension of the resin when the surface of the recording medium is coated, and has the advantage that the protective layer can be formed with a uniform thickness distribution at the surface of the recording medium.

In addition, it is more effective when a protective layer is formed at the surface of a thin recording medium with a thickness of about 10˜20 μm.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A recording medium surface coating apparatus comprising:
a medium mounting unit having a rotational shaft and a mounting surface with a plurality of medium mounting recesses in which a recording medium is mounted, the medium mounting unit being coupled to the rotational shaft and rotated;
a coating material supply unit installed along the rotational shaft and supplying a coating material to the surface of the recording medium; and
a driving unit for rotating the medium mounting unit.

2. The coating apparatus of claim 1, wherein the plurality of mounting recesses are radially arranged by forming a circle centering around the rotational shaft.

3. The coating apparatus of claim 1, wherein the plurality of mounting recesses have the same depth as a thickness of the recording medium.

4. The coating apparatus of claim 1, wherein the recording medium is an optical disk.

5. The coating apparatus of claim 1, wherein the mounting recess includes a fixing unit at its bottom in order to fix the recording medium to the mounting recess.

6. The coating apparatus of claim 5, wherein the fixing unit fixes the recording medium by making the bottom of the recording medium to be vacuumized when the recording medium is mounted.

7. The coating apparatus of claim 1, wherein the recording medium is formed in a circular shape.

8. The coating apparatus of claim 1, wherein the mounting unit is formed in a circular shape.

9. A surface coating apparatus comprising:
a mounting unit having a rotational shaft and a mounting surface with a plurality of medium mounting recesses on which a surface-process subject is mounted, the mounting unit being coupled to the rotational shaft and rotated;
a coating material supply unit installed along the rotational shaft and supplying a coating material to the surface of the surface-process subject; and
a driving unit for rotating the mounting unit.

10. A recording medium coating method comprising the steps of:
inserting a plurality of recording mediums into medium mounting recesses of a mounting unit;
rotating the mounting unit;
supplying a coating material onto the mounting unit to coat a coating material on the surface of the recording medium by using a centrifugal force according to rotation of the mounting unit; and
finishing the coating operation.

11. The coating method of claim 10, wherein the plurality of mounting recesses are radially arranged to form a circle centering around the rotational shaft.

12. The coating method of claim 10, wherein the plurality of mounting recesses have the same depth as a thickness of the recording medium.

13. The coating method of claim 10, wherein the recording medium is an optical disk.

14. The coating method of claim 10, wherein the mounting recess includes a fixing unit at its bottom in order to fix the recording medium.

15. The coating method of claim 14, wherein the fixing unit fixes the recording medium by making the bottom of the recording medium to be vacuumized when the recording medium is mounted.

16. The coating method of claim 10, wherein the recording medium is formed in a circular shape.

17. The coating method of claim 10, wherein the mounting unit is formed in a circular shape.
